(19) United States
(12) Patent Application Publication
(10) Pub. No.: US 2008/0077314 A1
(43) Pub. Date: Mar. 27, 2008

(54) Navigation device

(75) Inventor: Hiroki Ishikawa, Okazaki-shi (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-shi (JP)

(21) Appl. No.: 11/898,590

(22) Filed: Sep. 13, 2007

(30) Foreign Application Priority Data
Sep. 27, 2006 (JP) 2006-262213

(51) Int. Cl. G01C 21/34; G06F 17/00; G06F 17/30; G06F 17/40

(52) U.S. Cl. 701/117

(57) ABSTRACT

Systems and methods store request frequencies arranged by time period, each request frequency indicating a frequency at which traffic information distribution is to be requested from an information distribution center. The systems and methods determine a request timing based on a current time and the stored request frequencies and determine whether the request timing has elapsed since a previous traffic information distribution request. When it is determined that the request timing has elapsed, the systems and methods transmit a request for distribution of the traffic information to the information distribution center and receive the requested traffic information distributed from the information distribution center.

### INCORPORATION BY REFERENCE

The disclosure of Japanese Patent Application No. 2006-262213 filed on Sep. 27, 2006, including the specification, drawings and abstract is incorporated herein by reference in its entirety.

### BACKGROUND

1. Related Technical Fields

Related technical fields include navigation devices, such as navigation devices for receiving traffic information, including congestion information, distributed from an information distribution center.

2. Description of the Related Art

Navigation devices installed in vehicles perform vehicle travel guidance so that a driver can reach a desired destination easily. Some navigation devices are capable of detecting the current position of the vehicle using a GPS receiver or the like, obtaining map data corresponding to the current position from a recording medium such as a DVD-ROM or an HDD or through a network, and displaying the obtained map data on a liquid crystal monitor. The map data is read from the recording medium or the like. On the basis of the map data, a map image of the periphery of the current vehicle position is drawn and displayed on the liquid crystal monitor. At the same time, a vehicle position mark is superposed on the map image and the map image is scrolled as the vehicle moves. Alternatively, the map image is fixed on the screen and the vehicle position mark is moved. Thus, the current location of the moving vehicle can be indicated.

Various information distribution centers generate traffic information from information collected by probe cars. The information distribution centers distribute the traffic information to navigation devices via a cellular telephone signal or the like.

For example, when the number of probe cars in a certain area (segment) is large or the traveling speed of the probe cars is slow, data reliability can be kept at a high level when the segment is short. Therefore the segment length is shortened when the number of cars is high and/or the travel speed is slow.

When the number of probe cars is small or the traveling speed of the probe cars is fast, the data inconsistency (noise) component of the segment can be removed by making the segment length long. Thereby, erroneous determinations may be reduced and data reliability may be increased.

Thus, the information distribution center distributes traffic information relating to the variable segment to a navigation device via a cellular telephone or the like together with position reference information employing latitude/longitude information such as shape data showing the shape of the roads in the segment (see, e.g., paragraphs [0022] to [0064] and FIGS. 1 to 12 of Japanese Patent Application Publication JP A 2006-31422).

However, when the navigation device receives the traffic information from the information distribution center via a cellular telephone or the like, a communication period occurs, and when the communication frequency is high, the communication fee for the navigation device increases.

### SUMMARY

In such systems described above, when the navigation device receives the traffic information from the information distribution center via a cellular telephone or the like, communication time is necessary and a communication period occurs. When the communication frequency is high, the communication time and thus a fee for the communication period increases.

Various exemplary implementations of the broad inventive principles described herein provide a navigation device capable of receiving distributed traffic information efficiently and shortening the duration of communication with an information distribution center. Thereby, for example, enabling a large reduction in the communication fee.

Various exemplary implementations provide systems and methods that may store request frequencies arranged by time period, each request frequency indicating a frequency at which traffic information distribution is to be requested from an information distribution center. The systems and methods may determine a request timing based on a current time and the stored request frequencies and may determine whether the request timing has elapsed since a previous traffic information distribution request. When it is determined that the request timing has elapsed, the systems and methods may transmit a request for distribution of the traffic information to the information distribution center and may receive the requested traffic information distributed from the information distribution center.

### BRIEF DESCRIPTION OF THE DRAWINGS

Exemplary implementations will now be described with reference to the accompanying drawings, wherein:

FIG. 1 is a block diagram showing an exemplary navigation system;

FIG. 2 is a block diagram showing an exemplary navigation device;

FIG. 3 shows an exemplary data structure of statistical traffic information;

FIG. 4 shows an exemplary data structure of request frequency data; and

FIG. 5 is a flowchart showing an exemplary traffic information acquisition method.

### DETAILED DESCRIPTION OF EMBODIMENTS

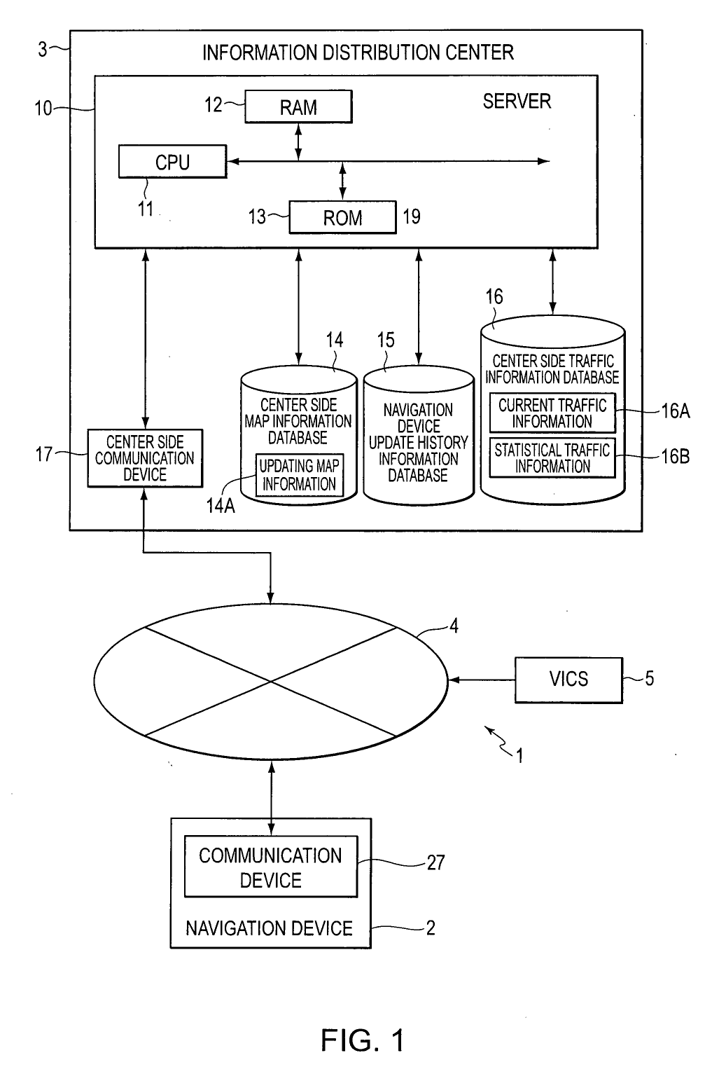

FIG. 1 shows an exemplary navigation system 1. As shown in FIG. 1, the navigation system 1 may include a navigation device 2, an information distribution center 3 for distributing update information (e.g., map information and traffic congestion information) to the navigation device 2, and a network 4. The navigation device 2 and the information distribution center 3 may transmit and receive various types of information via the network 4.

A vehicle information and communication system 5 (e.g., VICS®) may also be connected to the network 4. The navigation device 2 and information distribution center 3 may receive traffic information (e.g., information relating to road congestion and traffic restriction information), which is created by collecting information from a traffic control system of the police or the Japan Highway Public Corporation. Such information may be received via the network 4 at predetermined time intervals.

This traffic information may be detailed information relating to road traffic information such as, for example, road congestion information regarding road congestion and traffic restriction information due to roadwork and construction work. When the detailed information is road congestion information, the information may include a VICS link ID, the actual length of the traffic jam, the time required to pass through the traffic jam, the degree of congestion (e.g., not congested, congested, the type of congestion), the vehicle speed through the traffic jam, the traveling time, the advancement direction of the congested lane, and/or the predicted time for the congestion to clear. When the detailed information is traffic restriction information, the information may include the VICS link ID, the duration of the roadwork or construction work, the type of traffic restriction (e.g., closed roads, alternate one way passage, and/or lane closure), and/or the times during which the restrictions apply.

As shown in FIG. 1, the information distribution center 3 may include a server 10, a center side map information database (DB) 14 that records map information, a navigation device update history information DB 15, a center side traffic information DB 16, and/or a center side communication device 17. The server 10 may include a CPU 11 serving as a calculation device and a controller for performing overall control of the server 10. Note that an MPU or the like may be used instead of the CPU 11.

The server 10 may include an internal storage device such as a RAM 12, which may be used as working memory when the CPU 11 performs various types of calculation processing. The server 10 may include a ROM 13, on which various control programs are recorded. Such programs may include a program for extracting update information for updating the map information of a predetermined area in the navigation device 2 to the latest version of the map information from the center side map information DB 14 on the basis of a request from the navigation device 2. Such programs may also include a program for performing map information updating processing for distributing the map information to the navigation device 2, a program for creating current traffic information on the basis of probe information gathered by a probe car. Such programs may also include a program for distributing probe information to the navigation device 2 via the network 4 on the basis of a request from the navigation device 2

Probe information may include, for example, the date and time, link information, the traffic condition, the vehicle position, a two-dimensional mesh ID of the vehicle position, a wiper operating condition, the external/road surface temperature, the weather, ABS (antilock brake system) operating information, the road surface condition, vehicle information (e.g., the vehicle type, the performance specifications, the vehicle speed, the passengers, the vehicle weight distribution ratio, and/or torque application) and/or traffic information collected from the vehicle information and communication system 5, and distributing this information to the navigation device 2 via the network 4 on the basis of a request from the navigation device 2, and so on.

Updating map information 14A, which is map information that may be created by the information distribution center 3 for updating the map information stored in the navigation device 2, may be separated into versions and stored in the center side map information DB 14. The center side map information DB 14 may also store update information for updating all or a part of the map information currently stored in the navigation device 2 to the updating map information 14A. Here, a version is creation time information for specifying the time at which the map information is created. By referring to the version, the creation time of the map information can be specified.

Various information required for performing route guidance and map display on the navigation device 2 may be recorded in the updating map information 14A stored in the center side map information DB 14. Such various information may include map display data for displaying a map, intersection data relating to intersections, node data relating to node points, link data relating to roads (road links) serving as a type of facility, search data for finding a route, store data relating to POIs (points of interest) such as stores serving as a type of facility, and/or search data for finding a geographical location.

As used herein, the term “link” refers to, for example, a road or portion of a road. For example, according to one type of road data, each road may consist of a plurality of componential units called links. Each link may be separated and defined by, for example, an intersection, an intersection having more than three roads, a curve, and/or a point at which the road type changes. As used herein the term “node” refers to a point connecting two links. A node may be, for example, an intersection, an intersection having more than three roads, a curve, and/or a point at which the road type changes. Unless indicated otherwise, the term “link” refers to road links rather than VICS® links.

The map display data may include units obtained by dividing an approximately 10 km-by-10 km two-dimensional mesh by 4 (length ½), 16 (¼), or 64 (⅛). The unit of each geographical area may be set such that the amount of data in each unit is substantially identical. The smallest unit, which is divided by 64, may have an area of approximately 1.25 km-by-1.25 km.

Node data may include data relating to actual road junctions (e.g., intersections, and/or T junctions), the coordinates (position) of node points set at predetermined distance intervals in accordance with the radius of curvature of each road and so on, node properties indicating whether a node corresponds to an intersection, a connection link number list (e.g., a list of link identification numbers that connect to nodes), an adjacent node number list (e.g., a list of node numbers of nodes that are located adjacent to other nodes via links), and/or the height (altitude) of each node point.

Link data may include data indicating the width, gradient, cant, bank, road surface condition, number of lanes, locations having a reduced number of lanes, locations having a narrow width, crossings, and so on of the road to which the link belongs, data relating to corners, indicating the radius of curvature, intersections, T junctions, and/or corner entrances and exits. Link data may include data relating to the properties of the road, indicating inclines, descents, and data relating to the road classification, indicating public highways such as national highways, prefectural highways, and narrow town roads or toll roads such as national expressways, urban expressways, public toll roads, and toll bridges. Furthermore, data relating to access roads (ramp ways) at the entrances and exits of toll roads, tollbooths (interchanges), may also be included as link data.

Data used to search for and display a route to a set destination may be recorded as search data. Such search data may include opportunity cost (hereinafter “cost”) data that is used to calculate a weighting of each node. Cost data may be determined, for example, according to left/right turns performed when passing through a node, the distance between links constituting the road, the road width, and/or the road classification. Search data may also include route display data for displaying a route selected as a result of a route search on the map on a liquid crystal display 25, and so on.

Data relating to POIs, such as hotels, hospitals, gasoline stands, parking lots, and tourist facilities in each location may be recorded as store data together with an ID specifying the POI. Voice output data for outputting predetermined information through a speaker 26 of the navigation device 2 are also recorded in the center side map information DB 14.

When a request is issued from the navigation device 2, the information distribution center 3 may update the map information stored in the navigation device 2 using the latest version of the updating map information 14A, from among the updating map information 14A stored in the center side map information DB 14. Specifically, when a request for distribution of the updating map information 14A is issued by the navigation device 2, updating is performed by distributing update information. The distributed update information is used for updating the map information currently stored in the navigation device 2 with the latest version of the updating map information 14A. Here, all of the latest version of the updating map information 14A may be transmitted to the navigation device 2, including, for example, new road information specifying new roads. Alternatively, the minimum required data (e.g., only information relating to the parts to be updated, including new road information specifying new roads) may be transmitted.

Information relating to the update history of the map information stored in the navigation device 2 up to the present may be stored in the navigation device update history information DB 15 together with a navigation device ID specifying the navigation device 2. The update history may indicate the version of the map information that is currently in use as the link data and the node data constituting the map information, and a new update history may be written every time the map information of the navigation device 2 is updated.

Current traffic information 16A such as probe information (described above), and information relating to current road congestion, which is created by collecting traffic information received from the vehicle information and communication system 5, may be stored in the center side traffic information DB 16. The center side traffic information DB 16 may also store statistical traffic information 16B generated on the basis of VICS® signals from the vehicle information and communication system 5 and past traffic information such as probe information collected from the probe cars.

Note that the statistical traffic information 16B may also include anticipated event information such as the planned location and time of an event such as a festival, a parade, or a fireworks display, and also statistical congestion information and congestion prediction information (e.g., information indicating that congestion occurs every weekday at a specific time on roads surrounding a train station or large commercial facility and that congestion occurs during summer holidays on roads surrounding beaches).

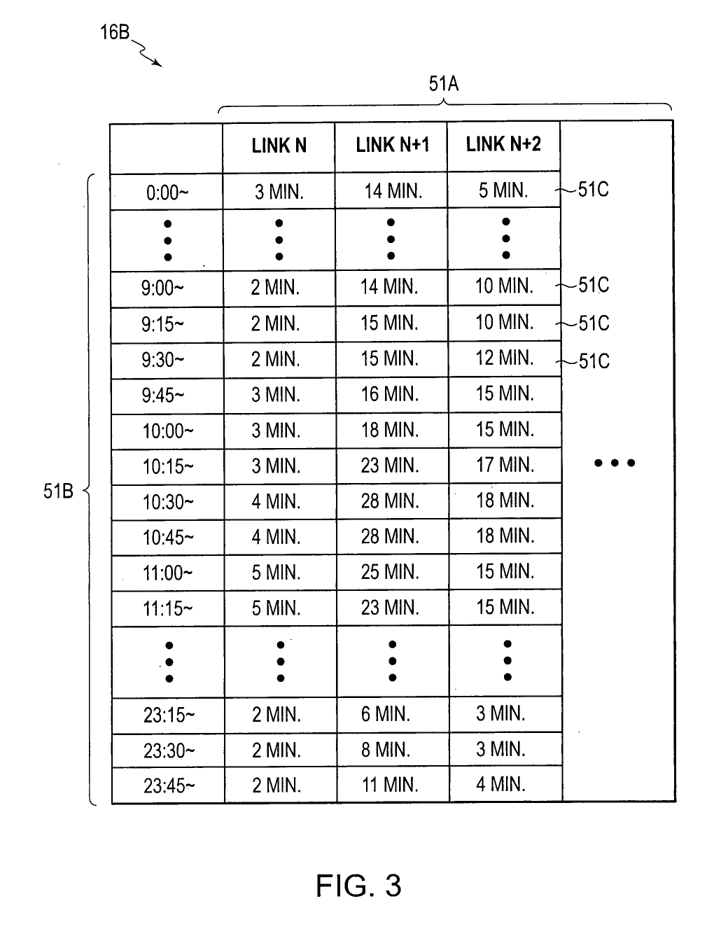

FIG. 3 is an illustrative view showing a data structure of the statistical traffic information 16B that may be stored in the center side traffic information DB 16. As shown in FIG. 3, the statistical traffic information 16B may be generated for each mesh ID attached to each two-dimensional mesh defining an area, and has a link cost 51C relating to a link ID 51A of each link for each time period 51B. The time period 51B may be set at 15 minute intervals (for example, “0:00” to “0:15” and soon). The link cost 51C maybe data indicating an average travel time required to pass through the link for the time period 51B, and may be indicated, for example, by “3 min.” The link cost 51C of the statistical traffic information 16B may be statistically generated by the information distribution center 3 on the basis of, for example, VICS® signals from the vehicle information and communication system 5 and/or past traffic information such as probe information collected from each probe car.

When a request is issued from the navigation device 2, the information distribution center 3 may selects and distributes traffic information relating to a section of road between two intersections, the statistical traffic information 16B or the like, on the basis of the current traffic information 16A stored in the center side traffic information DB 16.

The traffic information received from the vehicle information and communication system 5 may also include road classification information, such as the position of traffic jams, distance between traffic jams, degree of congestion, and/or a VICS link ID. The VICS link ID is an identification number attached to a VICS link serving as a standardized travel guidance type of link obtained by dividing a road into predetermined intersection intervals. Note that the aforementioned traffic information also includes information such as the coordinates of the start point and the end point of each VICS link, and the distance from the start point to the end point.

Here, the links stored in the center side map information DB 14 and the VICS links are not identical (typically, the links are more fragmented than the VICS links). Therefore, a table for mutually converting link IDs and VICS link IDs that are associated with roads may be provided so that a link ID can be specified on the basis of a corresponding VICS link ID. In so doing, the traffic information can be transmitted after converting the VICS link IDs into the link IDs that are used in the navigation device 2.

Note that the information distribution center 3 may be run by an individual, a business enterprise, an association, a local authority, a government-affiliated organization, and so on, or by the vehicle information and communication system 5.

The network 4 may include a communication system of any communication network such as a LAN (Local Area Network), a WAN (Wide Area Network), the Intranet, a cellular telephone network, a telephone network, a public communication network, a private communication network, and/or the Internet. A communication system employing satellite CS broadcasting, BS broadcasting, digital terrestrial broadcasting, FM multiplex broadcasting, and so on may also be used. Furthermore, a communication system used in an intelligent transport system (ITS), such as an electric toll collection (ETC) and a dedicated short-range communications (DSRC), may also be used.

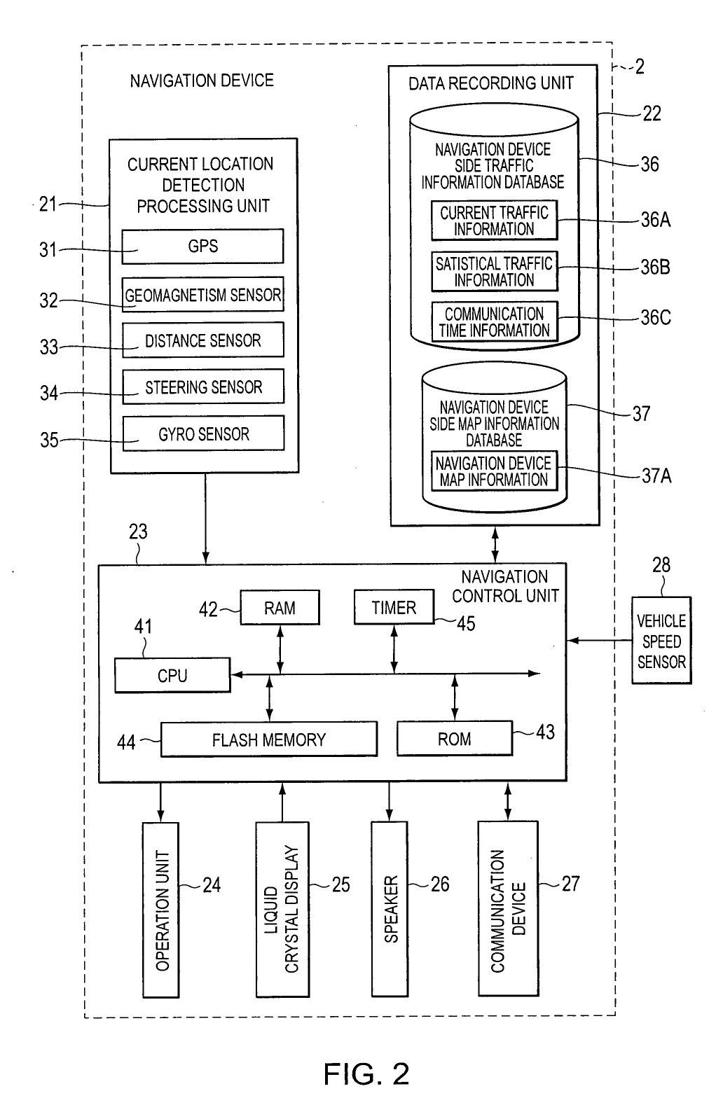

Next, an exemplary navigation device 2 that may be used in the navigation system 1 will be described using FIG. 2. As shown in FIG. 2, the navigation device 2 may include a current location detection processing unit 21 for detecting the current position of the vehicle, a data recording unit 22 in which various types of data are recorded, and a controller (navigation control unit 23) for performing various types of calculation processing on the basis of input information. The navigation device 2 may include an operation unit 24 for receiving an operation from an operator, a liquid crystal display 25 for displaying information such as maps to the operator, a speaker 26 for outputting voice guidance relating to route guidance, and a communication device 27 for performing communication with the vehicle information and communication system 5, the information distribution center 3, and so on via a cellular telephone network or the like. A vehicle speed sensor 28 for detecting the traveling speed of the vehicle may also be connected to the navigation control unit 23.

The current location detection processing unit 21 may be constituted by a GPS 31, a geomagnetism sensor 32, a distance sensor 33, a steering sensor 34, a gyro sensor 35 serving as a bearing detection unit, and/or an altimeter (not shown), and may be capable of detecting the current position and bearing of the vehicle, the distance to a target (e.g., an intersection), and so on.

Specifically, the GPS 31 may detect the current vehicle location and current time by receiving radio waves generated by artificial satellites. The geomagnetism sensor 32 may detect the bearing of the vehicle by measuring geomagnetism. The distance sensor 33 may detect distances between predetermined positions on a road. A sensor that measures the rotation speed of the vehicle wheels (not shown) and detects distances on the basis of the measured rotation speed, a sensor that detects distances by measuring the acceleration and integrating the measured acceleration twice, or another sensor may be used as the distance sensor 33.

The steering sensor 34 may detect the steering angle of the vehicle. An optical rotation sensor attached to the rotary portion of a steering wheel (not shown), a rotational resistance sensor, an angle sensor attached to a vehicle wheel, and so on may be used as the steering sensor 34.

The gyro sensor 35 may detect the traversing angle of the vehicle. Here, a gas rate gyro, a vibrating gyro, or another gyro is used as the gyro sensor 35. Furthermore, by integrating the traversing angle detected by the gyro sensor 35, the bearing of the vehicle can be detected.

The data recording unit 22 may include a hard disk (not shown) serving as an external storage device and storage medium, and a recording head (not shown) serving as a driver for reading a navigation device side traffic information DB 36, a navigation device side map information DB 37, predetermined programs, and so on from the hard disk and writing predetermined data to the hard disk. A magnetic disk such as a flexible disk may also or alternatively be used as the external storage device. A memory card, magnetic tape, a magnetic drum, a CD, an MD, a DVD, an optical disk, an MO, an IC card, an optical card, and so on may also be used as the external storage device.

The navigation device side traffic information DB 36 may store current traffic information 36A created from traffic information that is received from the information distribution center 3 and the vehicle information and communication system 5. The current traffic information 36A may include traffic congestion information relating to current road congestion conditions, such as the actual length of the traffic jam, the time required to travel through the traffic jam, the cause of the traffic jam, the predicted time required for the traffic jam to clear, and the like as well as traffic restriction information due to roadwork, construction work, and so on.

The navigation device side traffic information DB 36 may also pre-store statistical traffic information 36B including past road traffic conditions. The statistical traffic information 36B may be updated using the statistical traffic information 16B described above (see FIG. 3), which is distributed from the information distribution center 3 via the communication device 27.

Note that the navigation device 2 may be updated by supplying the statistical traffic information 16B using a CD-ROM or the like, or the link cost 51C of each link relative to each time period 51B may be updated at predetermined intervals (e.g. between one week and three months) on the basis of the vehicle traveling history.

The statistical traffic information 36B may also include anticipated event information such as the planned location and time of an event such as a festival, a parade, or a fireworks display, and also statistical congestion information and congestion prediction information, for example, information indicating that congestion occurs every weekday at a specific time on roads surrounding a train station or large commercial facility and that congestion occurs during summer holidays on roads surrounding beaches.

Communication time information 36C in the navigation device side traffic information DB 36 may include request frequency data used when determining the request frequency at which the distribution of traffic information, including congestion information, is requested from the information distribution center 3, as will be described below.

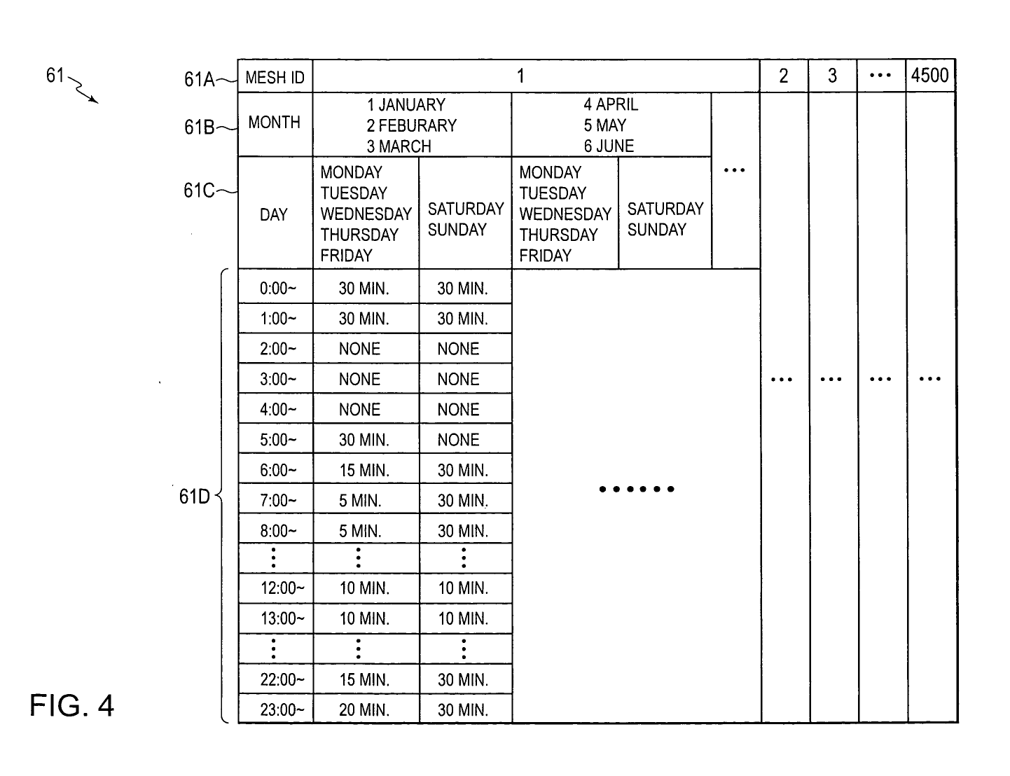

FIG. 4 is an illustrative view showing the data structure of the request frequency data stored in the communication time information 36C. As shown in FIG. 4, the request frequency data 61 may be set with a request frequency 61D at which the distribution of traffic information, including congestion information, is requested from the information distribution center 3 per mesh ID 61A (an ID allocated to each two-dimensional mesh serving as an area), month 61B, and day 61C. The lower order data of the mesh ID 61A is the month 61B. In the month 61B, the request frequency 61D may be substantially divided into seasons of, for example, “January to March,” “April to June,” “July to September,” and “October to December.” In the day 61C, which is at an even lower order, the request frequency 61D is divided into weekdays, i.e. “Monday to Friday,” and weekends, i.e. “Saturday and Sunday.”

The request frequency 61D may be stored for each mesh and, in each mesh, data expressing the time interval at which the distribution of traffic information including congestion information is requested from the information distribution center 3 within a predetermined time period of one hour may be stored in one hour units for a twenty-four hour period. In other words, each request frequency 61D may take into consideration the factors related to the mesh ID 61A (locality), the month 61B, the day 61C, and the time period.

For example, when the mesh ID 61A is “1,” the month 61B is “February,” the day 61C is “Monday,” the time is “0:54,” and the request frequency 61D is “30 minutes,” requests for the distribution of traffic information including congestion information from the information distribution center 3 are performed at 30 minute intervals. Further, when the mesh HD 61A is “1,” the month 61B is “March,” the day 61C is “Tuesday,” the time is “2:17,” no requests for the distribution of traffic information including congestion information from the information distribution center 3 are performed. When the mesh ID 61A is “1,” the month 61B is “January,” the day 61C is “Sunday,” the time is “12:38,” requests for the distribution of traffic information including congestion information from the information distribution center 3 are performed at 10 minute intervals.

The navigation device side map information DB 37 may also store navigation device map information 37A that is used by the navigation device 2 during travel guidance and route searching and updated by the information distribution center 3. Here, the navigation device map information 37A may be constituted by various types of information required for route guidance and map display, similarly to the updating map information 14A. The navigation device map information 37A may include new road information for specifying new roads, map display data for displaying a map, intersection data relating to intersections, node data relating to node points, link data relating to roads (links), which are a type of facility, search data for finding a route, store data relating to POIs such as stores, which are a type of facility, and search data for finding a location. The details of these data have been described above, and are therefore omitted here. The content of the navigation device side map information DB 37 may be updated by downloading update information distributed from the information distribution center 3 via the communication device 27.

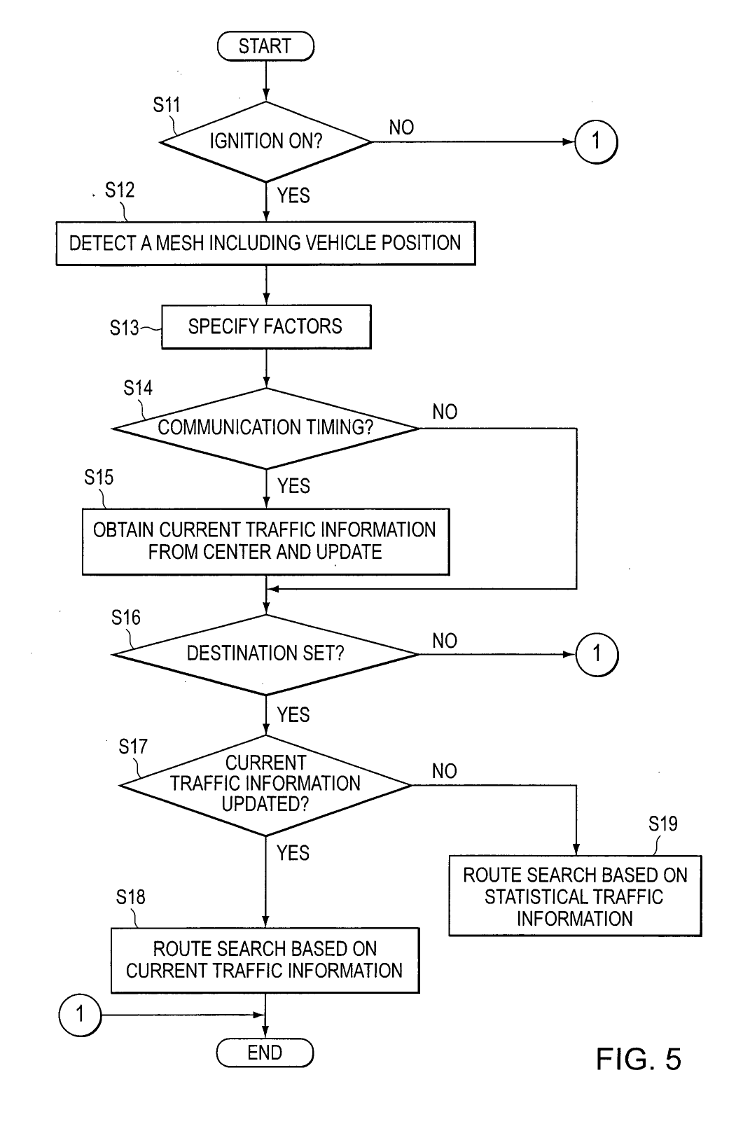

As shown in FIG. 2, the navigation control unit 23 of the navigation device 2 may include a CPU 41 serving as a calculation device and a control device for performing overall control of the navigation device 2, a RAM 42 that is used as working memory when the CPU 41 performs various types of calculation processing and stores route data generated when searching for a route, traffic information received from the information distribution center 3, and so on. The navigation control unit 23 may include a ROM 43 storing control programs and other programs such as a traffic information acquisition program (see, e.g., FIG. 5), for determining whether to obtain traffic information from the information distribution center 3. The navigation control unit 23 may include an internal storage device such as flash memory 44 for storing programs read from the ROM 43, a timer 45 for measuring time, and so on. Note that a semiconductor memory, a magnetic core, or another type of memory may be used as the RAM 42, ROM 43, and flash memory 44. Also, an MPU or the like may be used as the calculation device and control device instead of the CPU 41.

Various programs may be stored in the ROM 43, and various data may be stored in the data storage unit 22. However, these programs, data, and so on may be read from the same external storage device, memory card, or the like and written to the flash memory 44. Furthermore, by exchanging the memory card or the like, the programs, data, and so on may be updated.

Peripheral devices (actuators) for the operation unit 24, the liquid crystal display 25, the speaker 26, and the communication device 27 may be connected to the navigation control unit 23.

The operation unit 24 may be operated when correcting the current location at the beginning of travel, inputting a departure point as a guidance start point and a destination serving as a guidance end point, searching for information relating to facilities, and so on, and may be constituted by various keys or a plurality of operating switches. On the basis of switch signals output by depressing the switches or the like, the navigation control unit 23 may perform control to execute various corresponding operations. Note that a keyboard, a mouse, a barcode reader, a remote control device for remote operations, a joystick, a light pen, a stylus pen, and so on may be used as the operation unit 24. The operation unit 24 may also be constituted by a touch panel provided on the front surface of the liquid crystal display 25.

In addition to a map based on the navigation device map information 37A and a route guidance screen displaying traffic information on each link, the liquid crystal display 25 may also display operation guidance, an operation menu, key guidance, a recommended route from the current location to the destination, guidance information along the recommended route, traffic information, news, weather forecasts, the time, mail, television programs, and so on. Note that a CRT display, a plasma display, or another display may be used instead of the liquid crystal display 25, and a hologram device or the like that projects a hologram onto the windscreen of the vehicle may also be used.

The speaker 26 may output voice guidance and so on for guiding traveling along the recommended route on the basis of an instruction from the navigation control unit 23. Here, examples of the voice guidance may include “turn right at intersection XX in 200 m” and “national road number XX is congested ahead.” The voice output through the speaker 26 may be a synthesized voice, various sound effects, and various types of guidance information recorded in advance on tape, memory, or the like.

The communication device 27 may be a communicating unit that performs communication with the information distribution center 3 via a cellular telephone network or the like, and transmits and receives the latest version of the update map information and the current traffic information to and from the information distribution center 3. The communication device 27 may also receive not only information from the information distribution center 3 but also traffic information including congestion information, restriction information, parking lot information, traffic accident information, service area congestion conditions, and so on from the vehicle information and communication system 5.

Next, an exemplary traffic information acquisition method will be described with reference to FIG. 5. The exemplary method may be implemented, for example, by one or more components of the above-described system 1. However, even though the exemplary structure of the above-described system 1 may be referenced in the description, it should be appreciated that the structure is exemplary and the exemplary method need not be limited by any of the above-described exemplary structure. For example the method may be implemented by a program stored in the RAM 42 or the ROM 43 and run by the CPU 41 of the navigation device 2 to determine whether obtain the current traffic information 16A from the information distribution center 3.

As shown in FIG. 5, in a step (abbreviated “S” hereafter) 11, the CPU 41 determines whether an ignition switch is ON, or in other words whether the engine of the vehicle has been started, for example, on the basis of a detection signal transmitted from a vehicle ECU (not shown). When the ignition switch is OFF (S11: NO), the method ends.

On the other hand, when the ignition switch is ON (S11: YES), the CPU detects the current position of the vehicle, for example, using the current location detection processing unit 21. The CPU 41 then reads the map data including the current position of the vehicle from the navigation device map information 37A, in S12, detects the mesh including the vehicle position on the basis of the map data, and obtains the mesh ID 61A of the mesh.

Next, in S13, the CPU 41 obtains the current date and time, for example, by reading the time data of the timer 45, and specifies the factors related to the month 61B, day 61C, and time period of the current time.

Next, in S14, the CPU 41 reads the request frequency 61D from the request frequency data 61 stored in the communication time information 36C on the basis of the mesh ID 61A of the mesh including the vehicle position, obtained in S12, and the factors related to the month 61B, day 61C, and time period of the current time, specified in S13. Such data may be stored as the request frequency 61D in the RAM 42. The CPU 41 then executes determination processing to determine whether a time period corresponding to the request frequency 61D has elapsed from the previous occasion on which distribution of the current traffic information 16A (including congestion information) was requested from the information distribution center 3. In other words, it is determined whether it is a communication time for requesting distribution of the current traffic information 16A. Note that when the CPU 41 requests distribution of the current traffic information 16A including congestion information from the information distribution center 3, the month 61B, day 61C, and time of the request may be stored in succession in the data storage unit 22.

Specifically, for example, when the mesh ID 61A obtained in S12 is “1,” and the current month 61B, day 61C, and time specified in S13 are “February,” “Monday,” and “0:34,” respectively, the request frequency 61D of the request frequency data 61 is “30 minutes.” Therefore the CPU 41 determines whether 30 minutes has elapsed from the previous occasion on which distribution of the current traffic information 16A was requested from the information distribution center 3.

As another example, when the mesh ID 61A obtained in S12 is “1,” and the current month 61B, day 61C, and time specified in S13 are “March,” “Tuesday,” and “2:41,” respectively, the request frequency 61D of the request frequency data 61 is “none.” Therefore, the CPU 41 determines that in this time period, no requests for distribution of the current traffic information 16A, including congestion information from the information distribution center 3 are performed, or in other words that it is not the communication timing for requesting distribution of the current traffic information 16A.

As another example, when the mesh ID 61A obtained in S12 is “1,” and the current month 61B, day 61C, and time period specified in S13 are “January,” “Sunday,” and “12:33,” respectively, the request frequency 61D of the request frequency data 61 is “10 minutes.” Therefore, the CPU 41 determines whether 10 minutes has elapsed from the previous occasion on which distribution of the current traffic information 16A was requested from the information distribution center 3.

When a time period corresponding to the request frequency 61D has elapsed from the previous occasion on which distribution of the current traffic information 16A was requested from the information distribution center 3 (S14: YES), in S15, the CPU 41 requests distribution of the current traffic information 16A from the information distribution center 3 through a cellular telephone or the like, and updates the current traffic information 36A in the navigation device side traffic information DB 36 on the basis of the received current traffic information 16A.

Accordingly, when the mesh ID 61A of the vehicle position is “1,” the current month 61B is “February,” the current day 61C is “Monday,” and the current time is “0:24,” the CPU 41 obtains the current traffic information 16A from the information distribution center 3 at 30 minute intervals using a cellular telephone or the like, and updates the current traffic information 36A. When the mesh ID 61A of the vehicle position is “1,” the current month 61B is “February,” the current day 61C is “Monday,” and the current time is “7:45,” the CPU 41 obtains the current traffic information 16A from the information distribution center 3 at 5 minute intervals using a cellular telephone or the like, and updates the current traffic information 36A. When the mesh ID 61A of the vehicle position is “1,” the current month 61B is “February,” the current day 61C is “Sunday,” and the current time is “7:17,” the CPU 41 obtains the current traffic information 16A from the information distribution center 3 at 30 minute intervals using a cellular telephone or the like, and updates the current traffic information 36A.

On the other hand, when a time period corresponding to the request frequency 61D has not elapsed from the previous occasion on which distribution of the current traffic information 16A was requested from the information distribution center 3 or the request frequency 61D corresponding to the various factors is “none” (S14: NO), the CPU 41 determines that it is not the communication timing for requesting distribution of the current traffic information 16A. In other words, the CPU 41 advances to S16 without updating the current traffic information 36A.

Next, in S16, the CPU 41 determines whether a destination has been input by an input operation or the like on the operation unit 24. When a destination has not been input (S16: NO), the method ends.

On the other hand, when it is determined that a destination has been input (S16: YES), the CPU 41 stores the coordinates of the destination in the RAM 42 temporarily, and then advances to S17.

In S17, the CPU 41 determines whether the current traffic information 36A has been updated. When the current traffic information 36A has been updated (S17: YES), the CPU 41 advances to S18. In S18, the CPU 41 searches for a recommended route from the current vehicle position to the destination on the basis of the current traffic information 36A, stores the recommended route in the RAM 42, and then the method ends.

On the other hand, when the current traffic information 36A has not been updated (S17: NO), the CPU 41, in S19, the CPU 41 searches for a recommended route from the current vehicle position to the destination on the basis of the statistical traffic information 36B stored in the navigation device side traffic information DB 36, for example, using a Dijkstra method or the like, stores the recommended route in the RAM 42, and then the method ends.

As described in detail above, the request frequency data 61, which determines the frequency of the distribution of the current traffic information 16A, is requested from the information distribution center 3, may be stored in advance in the communication time information 36C. Then, when the ignition switch is ON (S11: YES), the CPU 41 may specifies the mesh ID 61A of the mesh including the vehicle position, and the current month 61B, day 61C, and time period (S12 to S13), and may reads the request frequency 61D from the request frequency data 61 stored in the communication time information 36C. If a time period corresponding to the request frequency 61D has elapsed from the previous occasion on which distribution of the current traffic information 16A was requested from the information distribution center 3, the CPU 41 issues a request to the information distribution center 3 for distribution of the current traffic information 16A and updates the current traffic information 36A in the navigation device side traffic information DB 36 on the basis of the received current traffic information 16A (S14 to S15).

Since the request frequency 61D of the request frequency data 61 is stored in advance for each time period, the request timing for requesting distribution of the current traffic information 16A from the information distribution center 3 can be determined on the basis of the request frequency 61D of each time period. Hence, in a time period having a low request frequency 61D, for example “0:00 to 2:00,” the request frequency 61D is “30 minutes,” and therefore request information requesting distribution of the current traffic information 16A is transmitted at a long time interval of “30 minutes.” In the time period “2:00 to 5:00,” the request frequency 61D is “none,” and therefore distribution of the current traffic information 16A is not requested. As a result, distribution of the current traffic information 16A may be requested fewer times during time periods in which congestion does not occur or the degree of congestion does not vary. Therefore the current traffic information 16A can be received more efficiently, enabling a reduction in the duration of communication with the information distribution center 3 via a cellular telephone or the like and a large reduction in communication fees.

Furthermore, the request frequency 61D may be set in accordance with each time period of each mesh ID 61A, and therefore the communication timing for requesting distribution of the current traffic information 16A can be determined in relation to each time period corresponding to the map mesh including the vehicle position while taking local factors into consideration.

For example, in a large metropolitan area such as Tokyo, traffic jams often occur during afternoon time periods, whereas outside of large metropolitan areas, traffic jams occur more often during morning and evening rush hour periods. Therefore, in large metropolitan areas, the time interval of the request frequency 61D during afternoon time periods can be set to be short, and outside of large metropolitan areas, the time interval of the request frequency 61D during morning and evening rush hour periods can be set to be short.

Further, when it is determined that the communication timing has not been reached on the basis of the current time, the CPU 41 may perform a route search using the statistical traffic information 36B generated in relation to each link on the basis of past traffic information (S16: YES to S17: NO to S19). Hence, even when the current traffic information 36A has not been updated, the time required to reach the destination from the departure point can be predicted accurately in each link with a high degree of responsiveness using the statistical traffic information 36B relating to each link.

When it is determined that the communication timing has been reached on the basis of the current time, the CPU 41 issues a request to the information distribution center 3 for distribution of the current traffic information 16A, updates the current traffic information 36A in accordance with the received current traffic information 16A, and then performs a route search on the basis of the updated current traffic information 36A (S16: YES to S17: YES to S18). Thus, the CPU 41 is able to perform a route search with an even higher degree of precision taking current congestion information and so on into account.

Furthermore, the request frequency data 61 may be generated for each mesh ID 61A, month 61B, and day 61C. Hence, in addition to the local factors of each two-dimensional mesh, the request frequency 61D is also determined in consideration of a seasonal factor and a temporal factor, and therefore the accuracy of the request frequency 61D set for each time period can be improved.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

For example, in S11, the CPU 41 determines whether the ignition switch is ON. Alternatively, the CPU 31 may determine whether a destination has been set via the operation unit 24. When a destination has been set (S11: YES), the CPU 41 may execute the processing of the S12 onward. Thus, during a route search, the CPU 41 may always check the request frequency data 61 before determining whether the communication timing has elapsed.

In the S11 the CPU may instead determine whether a request for the display of traffic information, including congestion information, on the liquid crystal display 25 has been issued via the operation unit 24. When a display request has been issued (S11: YES), the CPU 41 may execute the processing of the S12 onward.

In the above embodiment, the request frequency 61D is divided into “5 minutes,” “10 minutes,” “15 minutes,” “30 minutes,” and “none” in relation to each time period of each mesh ID 61A, month 61B, and day 61C. However, the request frequency 61D may be divided into either “requested,” indicating that distribution of the current traffic information 16A is to be requested, or “not requested,” indicating that distribution of the current traffic information 16A is not to be requested, in relation to each time period of each mesh ID 61A, month 61B, and day 61C.

In so doing, the CPU 41 is always able to update the current traffic information 36A during time periods in which the degree of congestion varies and time periods in which congestion occurs, such as morning and evening rush hours. Moreover, during time periods in which congestion does not occur and time periods in which the degree of congestion does not vary, the CPU 41 does not issues a request to the information distribution center 3 for distribution of the current traffic information 16A, including congestion information, enabling a reduction in the duration of communication with the information distribution center 3 via a cellular telephone or the like and a large reduction in communication fees. Moreover, the traffic information can be utilized with a high degree of responsiveness.

While the vehicle travels on the basis of the found route in the S19, the CPU 41 may measures the traveling speed and traveling time of each link in succession, and when a difference between the traveling speed and traveling time and a traveling speed and traveling time predicted during the route search exceeds a predetermined threshold (e.g., when the traveling speed of a link varies by 5 km per hour or more, or when the predicted traveling time of a link varies by 5 minutes or more), the CPU 41 may issues a request to the information distribution center 3 for distribution of the current traffic information 16A. As a result the OCPU 41 may update the current traffic information 36A in the navigation device side traffic information DB 36 on the basis of the received current traffic information 16A and then perform a new route search.

Thus, even when the statistical traffic information 36B cannot be applied due to factors such as a traffic accident and traffic restrictions, the CPU 41 can perform a route search with a high degree of precision, taking current congestion information and so on into account, after updating the current traffic information 36A.

When the CPU 41 issues a request to the information distribution center 3 via a cellular telephone or the like for distribution of the current traffic information 16A in S15, probe information that has been collected and stored in the data recording unit 22 may be transmitted to the information distribution center 3.

Thus, during time periods in which the degree of congestion varies and time periods in which congestion occurs, such as morning and evening rush hours, the CPU 41 can transmit the probe information to the information distribution center 3 reliably. Further, during time periods in which congestion does not occur and time periods in which the degree of congestion does not vary, the CPU 41 can reduce the number of times the probe information is transmitted to the information distribution center 3, enabling a reduction in the duration of communication with the information distribution center 3 via a cellular telephone or the like and a large reduction in communication fees.

Further, the request frequency data 61 may be set in consideration of factors such as holidays, consecutive holidays, and event information, and may also be set in relation to administrative districts such as prefectures, cities, wards, towns, and villages instead of the mesh ID 61A attached to the two-dimensional mesh.

What is claimed is:

1. A navigation device for installation in a vehicle, comprising:
a memory that stores request frequencies arranged by time period, each request frequency indicating a frequency at which traffic information distribution is to be requested from an information distribution center; and
a controller that
determines a request timing based on a current time and the stored request frequencies;
determines whether the request timing has elapsed since a previous traffic information distribution request;
when it is determined that the request timing has elapsed, transmits a request for distribution of the traffic information to the information distribution center; and
if the request is transmitted, receives the requested traffic information distributed from the information distribution center.

2. The navigation device according to claim 1, wherein:
the stored request frequencies are arranged by area; and
the controller:
detects an area that includes the vehicle position; and
determines the request timing based on the detected area.

3. The navigation device according to claim 1, wherein:
the memory stores statistical traffic information that is generated for each link on the basis of past traffic information;
when it is determined that the request timing has not elapsed, a route search is performed using the statistical traffic information; and
when it is determined that the request timing has elapsed, the route search is performed using the traffic information received from the information distribution center.

4. The navigation device according to claim 1, wherein the stored request frequencies are arranged by month and day.

5. The navigation device according to claim 1, wherein the controller:
records traveling information as probe information; and
when it is determined that the request timing has elapsed, transmits the recorded probe information to the navigation center.

6. The navigation device according to claim 1, wherein the request frequencies include time intervals.

7. The navigation device according to claim 1, wherein the request frequencies include at least one of “requested” or “not requested.”

8. The navigation device according to claim 1, further comprising an operation unit, wherein:
when a request is input on the operation unit, the controller transmits a request for distribution of the traffic information to the information distribution center.

9. The navigation device according to claim 1, wherein the controller:
determines whether a destination has been entered; and
if a destination has been entered, determines whether the request timing has elapsed.

10. A navigation system, comprising:
the navigation device of claim 1: and
the information distribution center.

11. An information acquisition method for use with a navigation device installed in a vehicle, comprising:
storing request frequencies arranged by time period, each request frequency indicating a frequency at which traffic information distribution is to be requested from an information distribution center; and
determining a request timing based on a current time and the stored request frequencies;
determining whether the request timing has elapsed since a previous traffic information distribution request;
when it is determined that the request timing has elapsed, transmitting a request for distribution of the traffic information to the information distribution center; and
if the request is transmitted, receiving the requested traffic information distributed from the information distribution center.

12. The method according to claim 11, further comprising:
storing the request frequencies arranged by area;
detecting an area that includes the vehicle position; and
determining the request timing based on the detected area.

13. The method according to claim 11, further comprising:
storing statistical traffic information that is generated for each link on the basis of past traffic information;
when it is determined that the request timing has not elapsed, performing a route search using the statistical traffic information; and
when it is determined that the request timing has lapsed, performing the route search using the traffic information received from the information distribution center.

14. The method according to claim 11, further comprising storing the request frequencies arranged by month and day.

15. The method according to claim 11, further comprising:
recording traveling information as probe information; and
when it is determined that the request timing has elapsed, transmitting the recorded probe information to the navigation center.

16. The method according to claim 11, wherein the request frequencies include time intervals.

17. The method according to claim 11, wherein the request frequencies include at least one of “requested” or “not requested.”

18. The method according to claim 11, further comprising:
receiving a request; and
based on the received request, transmitting a request for distribution of the traffic information to the information distribution center.

19. The method according to claim 11, further comprising:
determining whether a destination has been entered; and
if a destination has been entered, determining whether the request timing has elapsed.

20. A navigation device for installation in a vehicle, comprising:
means for storing request frequencies arranged by time period, each request frequency indicating a frequency at which traffic information distribution is to be requested from an information distribution center; and
means for determining a request timing based on a current time and the stored request frequencies;
means for determining whether the request timing has elapsed since a previous traffic information distribution request;
means for transmitting, when it is determined that the request timing has elapsed, a request for distribution of the traffic information to the information distribution center; and
means for receiving, if the request is transmitted, the requested traffic information distributed from the information distribution center.
